(19) United States
(12) Patent Application Publication
(10) Pub. No.: US 2017/0147035 A1
(43) Pub. Date: May 25, 2017

(54) HINGE DEVICE AND ELECTRONIC DEVICE COMPRISING THE HINGE DEVICE

(71) Applicant: Lenovo (Beijing) Limited, Beijing (CN)

(72) Inventors: Xiaoqin Han, Beijing (CN); Beiou Luan, Beijing (CN)

(21) Appl. No.: 15/083,951

(22) Filed: Mar. 29, 2016

(30) Foreign Application Priority Data
Nov. 20, 2015 (CN) 201510812074.X
Nov. 20, 2015 (CN) 201510813153.2

(51) Int. Cl. G06F 1/16

(52) U.S. Cl. CPC G06F 1/1616; G06F 1/1681

(57) ABSTRACT

One embodiment provides an electronic device, including: a first body; a second body; a first connector configured to couple to the first body of the electronic device; a second connector configured to couple to the second body of the electronic device; and a linkage assembly coupled to the first and second connectors, wherein the linkage assembly comprises a plurality of first linkages configured to couple with respective ones of the first and second connectors, and an intermediate linkage configured to couple to the first linkages, such that a rotation of the first connector along a direction causes a motion of the intermediate linkage which correspondingly rotates the second connector along an opposite direction. Other aspects are described and claimed.

### CLAIM FOR PRIORITY

This application claims priority to Chinese Application Nos. 201510813153.2 and 201510812074.X, both of which were filed on Nov. 20, 2015, and which are fully incorporated by reference herein.

### FIELD

The subject matter described herein relates to the technical field of mechanical industry, more specifically, it relates to a hinge device, and further relates to an electronic device using the hinge device.

### BACKGROUND

As the world progresses, electronic devices are more and more widely used in production activities and in people's daily lives. The electronic device comprises a first main body and a second main body, and the first main body can be pivotally mounted on the second main body and can be rotated around the second main body via a hinge device.

In the electronic devices of prior art, when the above-described two main bodies are opened, the hinge device can only drive one main body to rotate gradually while the other main body is in a stationary state. In other words, when a user switches the electronic device from a closed state to a working state (if the electronic device were a tablet), the user needs to rotate one of the main bodies by 360 degrees to complete the switch. The user is unable to open the two main bodies of the electronic device quickly, making it inconvenient for users.

### BRIEF SUMMARY

In summary, one aspect provides an electronic device, comprising: a first body; a second body; a first connector configured to connect with the first body of the electronic device; a second connector configured to connect with the second body of the electronic device; and a linkage assembly coupled to the first and second connectors, wherein the linkage assembly comprises a plurality of first linkages configured to couple with respective ones of the first and second connectors, and an intermediate linkage configured to couple to the first linkages, such that a rotation of the first connector along a direction causes a motion of the intermediate linkage which correspondingly rotates the second connector along an opposite direction.

Another aspect provides a hinge, comprising: a first connector configured to connect with a first body of an electronic device; a second connector configured to connect with a second body of the electronic device; and a linkage assembly coupled to the first and second connectors, wherein the linkage assembly comprises a plurality of first linkages configured to couple with respective ones of the first and second connectors, and an intermediate linkage configured to couple to the first linkages, such that a rotation of the first connector along a direction causes a motion of the intermediate linkage which correspondingly rotates the second connector along an opposite direction.

A further aspect provides a hinge for an electronic device, the hinge comprising: a holding frame; a first shaft, wherein the first shaft is coupled to a first body of the electronic device, and the first shaft is inserted in a first mounting hole of the holding frame rotatably about its own axis; a second shaft, wherein the second shaft is coupled to a second body of the electronic device, and the second shaft is inserted in a second mounting hole of the holding frame rotatably about its own axis, wherein the first shaft is coupled to the second shaft by means of a flexible connecting member, and in response to the first shaft rotating about its own axis in a first direction, the first shaft operatively drives, by means of the flexible connecting member, the second shaft to rotate about its own axis in a direction opposite to the first direction.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 depicts a hinge device in an embodiment;

FIG. 2 is a side view of the hinge device as shown in FIG. 1;

FIG. 3 shows the hinge device of FIG. 2 as seen from another angle;

FIG. 4 is a top view of the hinge device of FIG. 3;

FIG. 5 shows a link of the hinge device of FIG. 2;

FIG. 6 depicts an embodiment of a hinge device;

FIG. 7 shows the hinge device of FIG. 6 as seen from another angle;

FIG. 8 is a side view of the hinge device of FIG. 7; and

FIG. 9 shows the hinge device of FIG. 6, wherein the linkage assembly comprises a flexible connecting element.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Disclosed is a hinge device, wherein, while rotating about its own axis in the first direction, a first hinge can drive, via a linkage assembly, a second hinge to rotate about its own axis in the opposite direction. In other words, when a user rotates the first main body, which is fixedly connected with the first hinge, in the first direction to open the first main body, the linkage assembly drives the second main body, which is fixedly connected with the second hinge, to rotate in the opposite direction. As a result, the actual angle formed by the two opened main bodies is larger than the angle by which the user rotates the first main body, enabling the two main bodies of an electronic device to be opened quickly, making it convenient for users. Also disclosed is an electronic device, which uses the above-described hinge device, and its first main body and second main body can be opened quickly, making it convenient for users.

Embodiments are clearly and comprehensively described below with reference to the accompanying figures. The described embodiments are merely a part of the embodiments, rather than all of the embodiments. All other embodiments derived by those having ordinary skills in the art based on the described embodiments, without making creative efforts, shall fall within the scope protected by described embodiments.

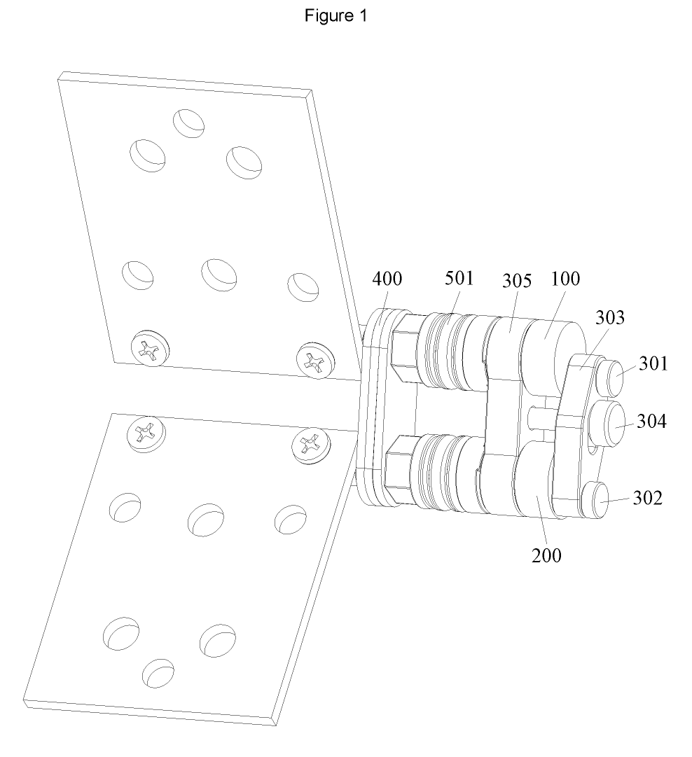

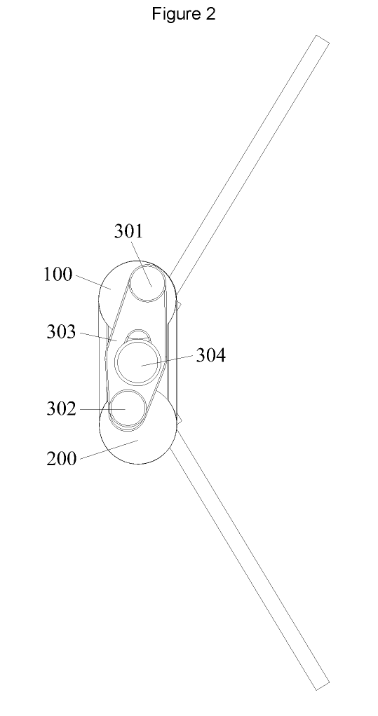

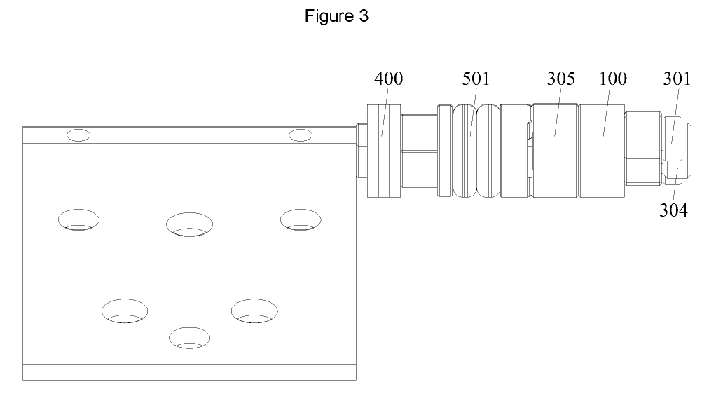

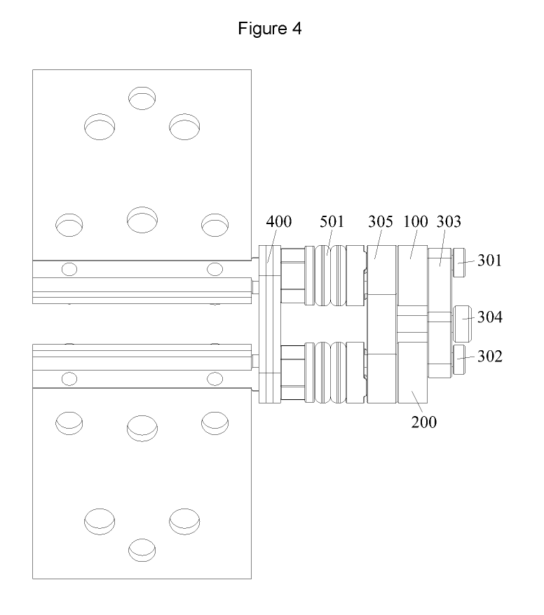

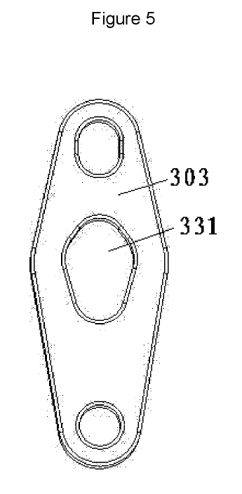

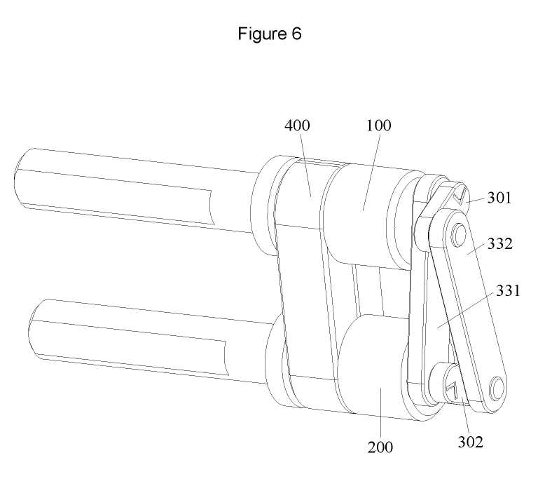

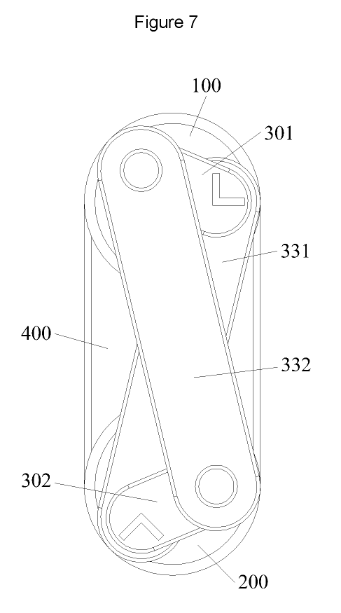

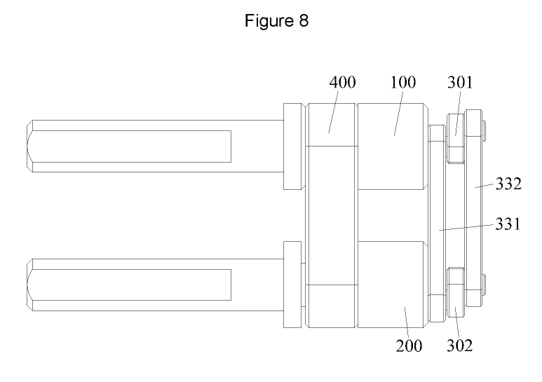

The disclosure now turns to a discussion of FIGS. 1 to 9, in which identical reference numerals are used throughout the figures to identify like components.

An embodiment provides a hinge device, comprising a retainer 400, a first hinge 100, a second hinge 200 and a linkage assembly, wherein the first hinge 100 is used for fixedly connecting with a first main body of an electronic device; and the first hinge 100 is inserted pivotally about its own axis into a first mounting hole of the retainer 400; and the second hinge 200 is used for fixedly connecting with a second main body of the electronic device, and the second hinge 200 is inserted pivotally about its own axis into a second mounting hole of the retainer 400; the second hinge 200 is in parallel to the first hinge 100; and the linkage assembly is connected with the first hinge 100 and the second hinge 200 respectively; wherein, when the first hinge 100 rotates about its own axis in the first direction, the first connecting surface of the first hinge 100 drives, via the linkage assembly, the second connecting surface of the second hinge 200 to rotate, and forces the second connecting shaft 302 to rotate about its own axis in the direction opposite of the above-described first direction; and the above-described first connecting surface is a surface on the first hinge 100 connected with the linkage assembly; and the second connecting surface is a surface on the second hinge 200 connected with the linkage assembly.

When the above-described hinge device is used for an electronic device, the rotating direction of the first main body relative to the second main body is set to be the first direction. Accordingly, when the first main body drives the first hinge 100 to rotate in the first direction, the linkage assembly drives the second hinge 200 to rotate in the direction opposite of the first direction through the connecting relationship between the first connecting surface and the second connecting surface, forcing the second main body to rotate in the direction opposite of the above-described first direction, so that the actual angle formed by the opened first main body and second main body is larger than the angle by which the first main body rotates, and the two main bodies of the electronic device can be opened quickly, making it convenient for users.

Based on the above, in order for the two main bodies of the electronic device to be closed quickly, the above-described hinge device is configured in such a way that, when the first hinge 100 rotates in the direction opposite of the first direction, the first connecting surface of the second hinge 200 drives, via the linkage assembly, the second connecting surface of the second hinge 200 to rotate, and forces the second hinge 200 to rotate about its own axis in the first direction. In this embodiment, when the first main body is closed relative to the second main body, the first main body rotates, while the linkage assembly can drive the second connecting surface of the second hinge 200 to rotate under the action of the first hinge 100, forcing the second main body to rotate in an opposite direction, so that the actual angle by which the first main body and the second main body are closed is larger than the angle by which the first main body rotates, and the electronic device can be closed quickly, making it more convenient for users to use.

The above-described first connecting surface is set to be the end face of the first hinge 100, and the second connecting surface is set to be the end face of the second hinge 200. In order to connect with the two main bodies of a notebook computer respectively, the above-described first hinge 100 and second hinge 200 are set in parallel. Depending on a particular structure of the linkage assembly, the above-described first connecting surface and second connecting surface can be set to be the end faces of the first hinge 100 and the second hinge 200 on the different side respectively. However, in order to save space and facilitate assembling, the above-described first connecting surface and second connecting surface are set to be the end faces of the first hinge 100 and the second hinge 200 on the same side respectively.

Accordingly, in an embodiment, the linkage assembly is configured to comprise: a first connecting shaft 301 having a first end mounted on the first connecting surface; a second connecting shaft 302, having a first end mounted on the second connecting surface; and a link 303 connected with the first connecting shaft 301 and the second connecting shaft 302; wherein, the linkage assembly is used for driving the first hinge 100 and the second hinge 200 to rotate in the opposite direction simultaneously about their own axis respectively. In the hinge device, the first hinge 100 and the second hinge 200 rotate simultaneously on their axis respectively. In other words, when the first main body is rotated, the second main body will be rotated simultaneously in an opposite direction under the action of the linkage assembly. The second main body rotates in the opposite direction without delay. The rotation of the second main body will be stopped immediately as soon as a user rotates the first main body to a desired angle, which saves time for the user and is convenient.

In an embodiment the linkage assembly is configured for making the second hinge 200 and the first hinge 100 to rotate about their own axis simultaneously in opposite directions by the same angle. When the hinge device is in use, when the first main body rotates by an angle “a”, the actual angle formed by the opened first main body and second main body will be “2a”.

In the process of using the above-described linkage assembly, the first connecting surface drives the first connecting shaft 301 to rotate, and the first connecting shaft 301 drives, via the link 303, the second connecting shaft 302 to rotate, while the second connecting shaft 302 drives the second connecting surface to rotate.

It will be understood by those skilled in the art that there is a critical point during the course when the driving shaft drives, via the link, the driven shaft to rotate. When the link moves to the critical point and the driving shaft continues to rotate following the trend of previous movement, the link is not only able to drive the driven shaft to continue rotating in the previous rotating direction, but also able to drive the driven shaft to rotate in the direction opposite of its previous rotating direction. Particularly, in the above-described embodiment, when the first connecting shaft 301 drives, via the link 303, the second connecting shaft 302 to rotate to the critical position, it is possible that it causes the second connecting shaft 302 to rotate in the direction opposite of its previous rotating direction, causing the second hinge 200 to rotate about its own axis in the same direction as the first hinge 100 does. As a result, quick opening and closing of the two main bodies of the electronic device will not be achieved. Therefore, in the hinge device provided by the above-described embodiment, when the first hinge 100 rotates about its own axis in the first direction, the link 303 moves along a first predetermined path; when the first hinge 100 rotates about its own axis in the direction opposite of the first direction, the link 303 moves in the direction opposite of the above-described first predetermined path.

In an embodiment, the first connecting shaft 301 is configured to comprise a first shaft pin, and the axis of the first shaft pin is parallel to the axis of the first hinge 100, and the first shaft pin is offset from the axis of the first hinge 100; the second connecting shaft 302 is configured to comprise a second shaft pin, the axis of the second shaft pin is parallel to the axis of the second hinge 200, and the second shaft pin is offset from the axis of the second hinge 200; and the two ends of the above-described link 303 are mounted on the first shaft pin and the second shaft pin respectively. It is apparent that in the above-described embodiment, the first shaft pin and the first hinge 100, the second shaft pin and second hinge 200 constitute a crankshaft respectively, and the two crankshafts are connected with the link 303 respectively to form a crankshaft-linkage structure.

In an embodiment, the linkage assembly limits movement path of the link 303 via link path limiting pin 304. The link path limiting pin 304 and the retainer 400 are relatively immovable (i.e., the link path limiting pin 304 and the retainer 400 are always kept relatively stationary). A position limiting hole is defined through the above link 303, and the link path limiting pin 304 mates with the above-described position limiting hole, so that the link 303 moves along the above-described first path or moves in the direction opposite of the first path. Particularly, the above-described link path limiting pin 304 can be fixed directly on retainer 400. It can also be fixed on a supporting bracket 305, which is mounted on the first hinge 100 and the second hinge 200.

In an embodiment, the first connecting shaft 301 can also be configured as a crankshaft, which comprises connecting plates and a third shaft pin and a fourth shaft pin inserted in the two ends of the connecting plates respectively. The axis of the above-described third shaft pin is parallel to the axis of the fourth shaft pin. One end of the third shaft pin is the first end of the first connecting shaft 301. The first end is mounted on the first connecting surface; the axis of the third shaft pin is parallel to the axis of the first hinge 100, and the axis of the third shaft pin is offset from the axis of the first hinge 100.

Accordingly, the second connecting shaft 302 is configured to have the same structure as the first connecting shaft 301, and the third shaft pin of the second connecting shaft 302 is mounted on the second connecting surface. The axis of the third shaft pin of the second connecting shaft 302 is parallel to the axis of the second hinge 200, and the third shaft pin of the second connecting shaft 302 is offset from the axis of the second hinge 200.

The above-described link 303 is configured as two links, wherein the two ends of the first link 331 are mounted on the third shaft pins of the two connecting shafts respectively, and the two ends of the second link 332 are mounted on the fourth shaft pins of the two connecting shafts respectively.

When the first hinge 100 rotates about its own axis in the first direction, the first link 331 and the second link 332 move along their corresponding first predetermined paths respectively; when the first hinge 100 rotates about its own axis in the direction opposite of the first direction, the first link 331 and the second link 332 move in the direction opposite of their corresponding first predetermined paths respectively.

In an embodiment, the first connecting shaft 301 and the second connecting shaft 302 are configured as a crankshaft respectively, and the two connecting shafts are connected by the first link 331 and the second link 332, so that the second connecting shaft 302 moves under the action of the second link 332 when the first link 331 reaches a critical position, and the second connecting shaft 302 moves under the action of the first link 331 when the second link 332 reaches a critical position, thus ensuring the two links to move along a first predetermined path or along the direction opposite of the first predetermined path respectively. In an embodiment, the connecting relationship between the third shaft pin, the fourth shaft pin and the connecting plates, the connecting relationship between the crankshaft and the first hinge 100 or the second hinge 200, and the connecting relationship between the crankshaft and the links, can be as follows:

(1) The third shaft pin and the fourth shaft pin are fixedly connected with the connecting plates respectively, and the third shaft pin is fixedly connected with the first hinge 100 or the second hinge 200. The two ends of the first link can be pivotally mounted on the third shaft pins of the two connecting shafts respectively, and the two ends of the second link can be pivotally mounted on the fourth shaft pins of the two connecting shafts respectively. The third shaft pins, the fourth shaft pins and the connecting plates can be configured as an integrated structure to facilitate fabrication.

(2) The first connecting plate is fixedly connected with the third shaft pins of the two connecting shafts respectively, and one end of the third shaft pin can be pivotally inserted into a socket on the first hinge 100 or the second hinge 200, and another end can be pivotally inserted into the first socket of the connecting plate. The second connecting plate is fixedly connected with the fourth shaft pins of the two connecting shafts respectively, and one end of the fourth shaft pin can be pivotally inserted into the second socket of the connecting plate.

(3) One end of the third shaft pin is fixedly connected with the connecting plate, and another end is fixedly connected with the first hinge 100 or the second hinge 200, and the two ends of the first link can be mounted pivotally about its own axis on the third shaft pins of the two connecting shafts respectively, and one end of the fourth shaft pin is inserted pivotally about its own axis into a socket of the connecting plate, and another end is fixedly connected with the second link.

Two or more fixedly connected components can be configured as an integrated structure to facilitate fabrication. Fixed connection can also be accomplished by welding or connecting by fixing elements.

In an embodiment, the linkage assembly can also be configured to comprise a flexible connecting element 310, and the two ends of the flexible connecting element 310 are fixed on the end face of the first hinge 100 and the end face of the second hinge 200 respectively. When the first hinge 100 rotates about its own axis, the first hinge 100 transmits torque to the second hinge 200 via the flexible connecting element 310, and drives the second hinge 200 to rotate about its own axis. Particularly, the above-described flexible connecting element 310 has an arcuate structure. When rotating about its own axis, the first hinge 100 drives the flexible connecting element 310 to twist about its own axis, thus driving the second hinge 200 to rotate about its own axis in the direction opposite of the direction of the first hinge 100.

In an embodiment, the flexible connecting element 310 can be configured as a flexible shaft made of flexible materials, or as a flexible shaft comprised of multiple strands of continuous wires. It can also be configured as a flexible shaft comprised of a plurality of successively connected joining elements.

Furthermore, in order to ensure that the flexible connecting element 310 only twists about its own axis when the first hinge 100 rotates about its own axis, an embodiment also has a supporting block 320 mounted on the first hinge 100 and the second hinge 200 respectively. A clamping groove is provided on the supporting block 320, and the flexible connecting element 310 is clamped in the above-described clamping groove. The above-described clamping groove may be configured to accommodate the entire flexible connecting element 310. However, in order to reduce the damping effect and to drive the second hinge 200 to rotate about its own axis for a larger angle when the flexible connecting element 310 twists about its own axis, the above-described clamping groove is preferably engaged only with the middle part of the flexible connecting element 310. In the hinge device provided by this embodiment, the angle by which the second hinge 200 rotates about its own axis under the action of the flexible connecting element is close to the angle by which the first hinge 100 rotates about its own axis.

Of course, in an embodiment, the first connecting surface and the second connecting surface can also be configured as the outer circumferential surface of the first hinge 100 and second hinge 200 respectively. Accordingly, the linkage assembly can be configured as two mutually engaged gears mounted on the first hinge 100 and the second hinge 200 respectively.

Preferably, in the hinge device provided by an embodiment, the first hinge 100 can be kept at any angle of rotation about its own axis.

Accordingly, when the first hinge 100 is kept at the first angle of rotation about its own axis, the second hinge 200 is kept at the second angle of rotation about its own axis and the second angle matches the first angle (i.e., the second angle is the angle by which the second hinge 200 rotates about the axis of the second hinge 200 when driven by the first hinge 100, via linkage assembly, when the first hinge 100 rotates about its own axis to the first angle), and the first angle and the second angle are in positive and negative values respectively.

In an embodiment, additional damping components can be provided to keep the first hinge 100 and the second hinge 200 at the above-described first angle and second angle respectively. Preferably, the above-described retainer 400 is a damping retainer 400 used for providing a damping effect to the first hinge 100 and the second hinge 200 to keep them at the first angle and the second angle respectively.

Particularly, a damping element such as a rubber ring can be provided in the first mounting hole and the second mounting hole of the damping retainer 400. However, in order to improve reliability and extend service life of the hinge device, the following structure is used:

A shaft shoulder and a lock nut 502 are provided on the first hinge 100 and second hinge 200 respectively. Under the joint action of the above-described shaft shoulder and lock nut 502, side faces of the retainer 400 closely contact the above-described shaft shoulder and lock nut 502. When the first hinge 100 rotates to the first angle, the part of the retainer 400 contacting the shaft shoulder of the first hinge 100 and the lock nut 502 provides a static frictional damping effect to the first hinge 100, keeping the first hinge 100 at the first angle. Accordingly, the part of the retainer 400 contacting the shaft shoulder and lock nut 502 of the second hinge 200 provides a static frictional damping effect to the second hinge 200, keeping the second hinge 200 at the second angle. Furthermore, in order to avoid the situation that the first hinge 100 and the second hinge 200 are unable to rotate about its own axis due to excessively large damping effect provided by the retainer 400, a disc spring is mounted on the above-described first hinge 100 and second hinge 200 respectively. The disc spring is located between the shaft shoulder and the lock nut 502, allowing the retainer 400 to only contact the shaft shoulder or the lock nut 502.

Of course, in an embodiment, the supporting bracket 305 or the supporting block 302 can be used in a similar configuration, as the above, to provide a damping effect to the first hinge and the second hinge. Accordingly, the retainer 400 can be mounted between the shaft shoulder and the lock nut 502, or outside the area between the shaft shoulder and the lock nut 502.

It can be seen in an embodiment that no matter the first main body and second main body are to be opened or closed, the first hinge 100 of the hinge device is always used as a driving shaft and the second hinge 200 is used as a driven shaft. It should be understood by those skilled in the art that the above-described results of quick opening and closing of the two main bodies of the electronic device can also be achieved by using the second hinge 200 as the driving shaft and the first hinge 100 as the driven shaft, and the process of opening and closing the two main bodies is the same as when the above-described first hinge 100 is used as the driving shaft.

The hinge device provided in an embodiment is simple in structure and convenient for fabrication. The components of the hinge device do not require sophisticated machining and processing, and the number and type of the components are minimal, making it easier to assemble and helps increase assembling efficiency. In an embodiment, the linkage assembly occupies little space, helping reduce the distance between the first hinge 100 and the second hinge 200, and helps make the electronic device lighter and thinner.

An embodiment also provides an electronic device, comprising the first main body, the second main body and the hinge device used for connecting the first main body with the second main body. The hinge device is the hinge device provided by the disclosure.

Connecting plates for the main bodies are fixed on the above-described first hinge 100 and second hinge 200 respectively. Assembly can be easily accomplished when the first main body and second main body are fixedly connected with the main body connecting plates of the first hinge 100 and the second hinge 200 respectively.

In an embodiment an electronic device uses an embodiment of a hinge device; as a result, the two main bodies can be opened quickly, making it convenient for users. Of course, the electronic device provided by this embodiment also has other functions in addition to the hinge device provided by embodiments.

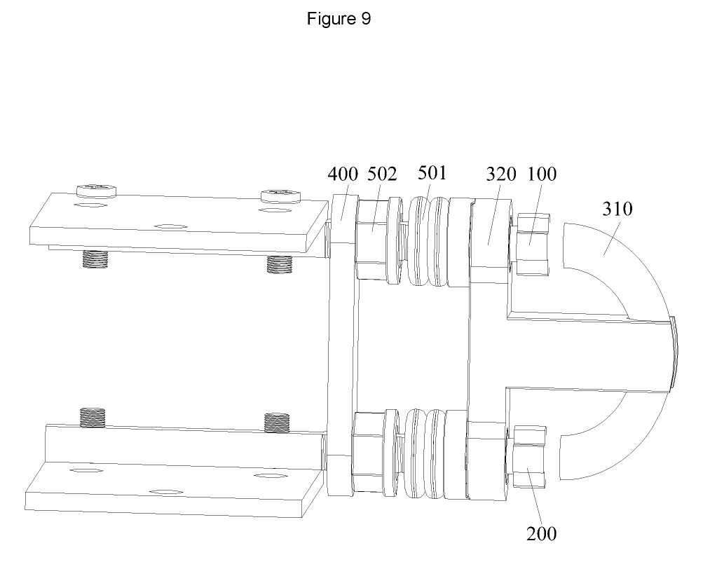

The disclosure now turns to a discussion of FIG. 9. In an embodiment, in order for the two bodies of the electronic device to be closed rapidly, the hinge is configured in such a manner that when the first shaft 100 rotates in the direction opposite to the first direction, the first shaft 100 drives, by means of the flexible connecting member, the second shaft 200 to rotate about its own axis in the first direction. In this implementation, when the first body is being closed towards the second body, the first body rotates in the direction opposite to the first direction, and at the same time, under the action of the first shaft 100, the flexible connecting member can drive the second shaft 200 to rotate about its own axis in the first direction, and thus cause the second body to rotate in the first direction. In this way, the actual closing angle between the first body and the second body is greater than the rotating angle of the first body, so that the first body and the second body can be closed rapidly, making it more convenient for the user.

In an embodiment, the flexible connecting member is a flexible shaft 310, the flexible shaft 310 bends to form an arc, a first end of the flexible shaft 310 is fixedly connected to an end part of the first shaft 100, and a second end of the flexible shaft 310 is fixedly connected to an end part of the second shaft 200; and when the first shaft 100 rotates about its own axis in the first direction or the direction opposite to the first direction, the flexible shaft 310 twists about its own axis from the first end to the second end and drives the second shaft 200 to rotate about its own axis in the opposite direction.

Further, to ensure that the flexible shaft 310 twists only about its own axis when the first shaft 100 rotates about its own axis, the hinge is further provided with a holding frame 320 sleeved on the first shaft 100 and the second shaft 200 respectively, clamping grooves are provided at the support frame 320, and the flexible shaft 310 is clamped in the clamping grooves. The clamping grooves can be configured to accommodate the entire flexible shaft 310; however, to reduce the damping produced when the flexible shaft 310 twists about its own axis, so as to drive the second shaft 200 to rotate by a greater angle about its own axis, the clamping groove is preferably configured to be in clamping engagement only with a middle part of the flexible shaft 310.

In an embodiment, the flexible shaft 310 is a flexible shaft 310 made of a flexible material, or a flexible shaft 310 consisting of multiple strands of continuous filaments, or a flexible shaft 310 consisting of multiple connecting blocks that are connected in sequence.

In an embodiment, the first shaft 100 of the hinge serves as a driving shaft and the second shaft 200 of the hinge serves as a driven shaft in the processes of opening and closing the first body and the second body. It may be appreciated by those skilled in the art that according to the hinge provided by the above-mentioned solution, the second shaft 200 may also serve as a driving shaft and the first shaft 100 may also serve as a driven shaft respectively in the processes of opening and closing the first body and the second body, and the detailed process is identical to the case in which the first shaft 100 serves as a driving shaft, which will not be described in detail herein again.

In an embodiment, the first shaft 100 not only can serve as a driving shaft in the process of opening the first body and the second body but also can serve as a driving shaft in the process of closing the two bodies. It should be appreciated by those skilled in the art that the hinge may also be configured in such a manner that the first shaft 100 serves only as a driving shaft in the process of opening the first body and the second body, and the second shaft 200 serves only as a driving shaft in the process of closing the first body and the second body; correspondingly, when the second shaft 200 rotates in the first direction, the second shaft 200 drives, by means of the flexible connecting member, the first shaft 100 to rotate about its own axis in the direction opposite to the first direction.

In an embodiment, the flexible connecting member is a connecting rope having two ends fixedly connected to the first shaft 100 and the second shaft 200 respectively; the connecting rope includes a first part wound around a periphery of the first shaft 100 and/or a second part wound around a periphery of the second shaft 200, and the flexible connecting member further includes a middle part located between the first shaft 100 and the second shaft 200, the middle part connecting the first part and the second part, and the middle part being tightly stretched by the first shaft 100 and the second shaft 200; the length of the first part increases and the length of the second part decreases when the first shaft 100 rotates about its own axis in the first direction; the length of the second part increases and the length of the first part decreases when the second shaft 200 rotates about its own axis in the first direction. The first part and the second part are wound in opposite directions, and the middle part is S-shaped.

It may be appreciated by those skilled in the art that the connecting rope may be configured to be longer so that the connecting rope always includes the first part, the second part, and the middle part; however, to save space, the connecting rope may also be configured to be shorter; correspondingly, the connecting rope includes only the middle part and the second part when the first body and the second body are at an angle of 0°, and the connecting rope includes only the first part and the middle part when the first body and the second body are opened at an angle of 360°.

Further, in an embodiment, helical grooves for engaging the connecting rope are provided on the first shaft 100 and the second shaft 200 respectively. When the first shaft 100 rotates about its own axis in the first direction, the connecting rope is gradually wound around the periphery of the first shaft 100 by means of the helical groove of the first shaft 100; and at the same time, the connecting rope is gradually released from the helical groove of the second shaft 200. When the second shaft 200 rotates about its own axis in the first direction, the connecting rope is gradually wound around the periphery of the second shaft 200 by means of the helical groove of the second shaft 200; and at the same time, the connecting rope is gradually released from the helical groove of the first shaft 100. The helical direction of the helical groove of the first shaft 100 is opposite to the helical direction of the helical groove of the second shaft 200.

In an embodiment, the first shaft 100 is configured in such a manner that the first shaft 100 can be held at any angle of rotation about its own axis.

Correspondingly, to ensure that the two bodies of the electronic device can be positioned at any opening angle, when the first shaft 100 is held at a first angle during the process of rotating about its own axis, the second shaft 200 is held at a second angle during the process of rotating about its own axis, the first angle being corresponding to the second angle, and a correspondence between the two angles is as follows:

(1) When the first shaft 100 serves not only as a driving shaft in the process of opening the two bodies of the electronic device but also as a driving shaft in the process of closing the two bodies, the second angle is an angle by which the second shaft 200 is driven by the first shaft 100 by means of the flexible shaft to rotate about its own axis when the first shaft 100 rotates about its own axis to the first angle.

(2) When the first shaft 100 serves only as a driving shaft in the process of opening the two bodies of the electronic device and the second shaft 200 serves only as a driving shaft in the process of closing the two bodies of the electronic device, the second angle is an angle by which the second shaft 200 is driven by the first shaft 100 by means of the flexible rope to rotate about its own axis in the direction opposite to the first direction when the first shaft 100 rotates about its own axis in the first direction to the first angle; or the first angle is an angle by which the first shaft 100 is driven by the second shaft 200 by means of the flexible rope to rotate about its own axis in the direction opposite to the first direction when the second shaft 200 rotates about its own axis in the first direction to the second angle.

Specifically, the hinge may be additionally provided with a damping component(s) so as to hold the first shaft 100 and the second shaft 200 to be at the first angle and the second angle respectively. Preferably, the holding frame 400 is configured as a damping holding frame 400 used for providing damping to hold the first shaft 100 and the second shaft 200 at the first angle and the second angle respectively.

Specifically, dampers such as rubber washers may be disposed in the first mounting hole and the second mounting hole of the damping holding frame 400; however, to improve the reliability and prolong the service life of the hinge, the following structure is used.

Shaft shoulders and lock nuts 502 are respectively provided on the first shaft 100 and the second shaft 200, and disc springs 501 located between the shaft shoulders and the lock nuts 502 are sleeved on the first shaft 100 and the second shaft 200 respectively. Under the joint action of the shaft shoulders, the disc springs 501, and the lock nuts 502, a side surface of the holding frame 400 presses against the shaft shoulders or the lock nuts 502. When the first shaft 100 rotates to the first angle, the part of the holding frame 400 that is in contact with the shaft shoulder or the lock nut 502 of the first shaft 100 provides static friction damping to the first shaft 100, so as to hold the first shaft 100 at the first angle; correspondingly, the part of the holding frame 400 that is in contact with the shaft shoulder or the lock nut 502 of the second shaft 200 provides static friction damping to the second shaft 200, so as to hold the second shaft 200 at the second angle. In this implementation solution, the disc springs 501 provide a pre-tightening force, which, on the one hand, prevents the holding frame 400 from providing excessive damping to impede the rotation of the first shaft 100 and the second shaft 200 about their axes, and on the other hand, ensures that the first shaft 100 and the second shaft 200 can be held at the first angle and the second angle respectively.

In an embodiment in which the flexible connecting member is configured as a flexible shaft, the support frame 320 may also be used to provide damping for the first shaft 100 and the second shaft 200 by using the above-mentioned configuration manner, as shown in FIG. 9.

Individual embodiments in this specification have been described in a progressive manner. What is focused in each embodiment is the difference from other embodiments. The identical or similar features among the individual embodiments can be identified by cross reference.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An electronic device, comprising:
a first body;
a second body;
a first connector configured to connect with the first body of the electronic device;
a second connector configured to connect with the second body of the electronic device; and
a linkage assembly coupled to the first and second connectors,
wherein the linkage assembly comprises a plurality of first linkages configured to couple with respective ones of the first and second connectors, and an intermediate linkage configured to couple to the first linkages, such that a rotation of the first connector along a direction causes a motion of the intermediate linkage which correspondingly rotates the second connector along an opposite direction.

2. The electronic device of claim 1, wherein a first connecting surface is an end face of the first connector, and a second connecting surface is an end face of the second connector.

3. The electronic device of claim 2, wherein the linkage assembly comprises:
a first connecting shaft having a first end mounted on the first connecting surface;
a second connecting shaft having a first end mounted on the second connecting surface;
a link connected with the first connecting shaft and the second connecting shaft; and
the linkage assembly is used for driving the first connector and the second connector to rotate simultaneously about its own axis respectively.

4. The electronic device of claim 3, wherein the link moves along a first predetermined path when the first connector rotates about its own axis in the first direction; and the link rotates in the direction opposite of the first predetermined path when the first connector rotates in the direction opposite of the first direction.

5. A hinge, comprising:
a first connector configured to couple to a first body of an electronic device;
a second connector configured to couple to a second body of the electronic device; and
a linkage assembly coupled to the first and second connectors,
wherein the linkage assembly comprises a plurality of first linkages configured to couple with respective ones of the first and second connectors, and an intermediate linkage configured to couple to the first linkages, such that a rotation of the first connector along a direction causes a motion of the intermediate linkage which correspondingly rotates the second connector along an opposite direction.

6. The hinge of claim 5, wherein a first connecting surface is an end face of the first connector, and a second connecting surface is an end face of the second connector.

7. The hinge of claim 6, wherein the linkage assembly comprises:
a first connecting shaft having a first end mounted on the first connecting surface;
a second connecting shaft having a first end mounted on the second connecting surface;
a link connected with the first connecting shaft and the second connecting shaft; and
the linkage assembly is used for driving the first connector and the second connector to rotate simultaneously about its own axis respectively.

8. The hinge of claim 7, wherein the link moves along a first predetermined path when the first connector rotates about its own axis in the first direction; and the link rotates in the direction opposite of the first predetermined path when the first connector rotates in the direction opposite of the first direction.

9. The hinge of claim 8, wherein the first connecting shaft comprises a first shaft pin, the axis of the first shaft pin is parallel to the axis of the first connector, and the first shaft pin is offset from the axis of the first connector; and the second connecting shaft comprises a second shaft pin, the axis of the second shaft pin is parallel to the axis of the second connector, and the second shaft pin is offset from the axis of the second connector; and two ends of the link are mounted on the first shaft pin and the second shaft pin respectively.

10. The hinge of claim 9, wherein a link path limiting pin of the linkage assembly and the retainer are relatively immovable; a position limiting hole is defined through the link; and the link path limiting pin mates with the position limiting hole.

11. The hinge of claim 8, wherein the first connecting shaft is a crankshaft, comprising a connecting plate, a third shaft pin and a fourth shaft pin being inserted respectively into two ends of the connecting plate, and the axis of the third shaft pin is parallel to the axis of the fourth shaft pin; and the third shaft pin is mounted on the first connecting surface; and the axis of the third shaft pin is parallel to the axis of the first connector, and the third shaft pin is offset from the axis of the first connector;
the second connecting shaft and the first connecting shaft have the same structure, the third shaft pin of the second connecting shaft is mounted on the second connecting surface, and the axis of the third shaft pin of the second connecting shaft is parallel to the axis of the second connector, and the third shaft pin of the second connecting shaft is offset from the axis of the second connector;
the quantity of the link is two, wherein two ends of a first link are mounted on the third shaft pins of the two connecting shafts respectively, and two ends of a second link are mounted on the fourth shaft pins of the two connecting shafts respectively;
the first link and the second link move along their corresponding first predetermined paths respectively when the first connector rotates about its own axis in the first direction.

12. The hinge of claim 5, wherein the linkage assembly comprises a flexible connecting element, and two ends of the flexible connecting element are fixedly connected with the first connector and the second connector respectively;
the first connector transmits torque to the second connector via the flexible connecting element and drives the second connector to rotate about its own axis in the direction opposite of the first direction when the first connector rotates about its own axis in the first direction.

13. The hinge of claim 12, wherein when the first connector is kept at a first angle of rotation about its own axis, the second connector is kept at a second angle of rotation about its own axis and the second angle matches the first angle.

14. The hinge of claim 13, wherein the retainer is a damping retainer for providing a damping effect to the first connector and the second connector to keep them at the first angle and the second angle respectively.

15. A hinge for an electronic device, the hinge comprising:
a holding frame;
a first shaft, wherein the first shaft is coupled to a first body of the electronic device, and the first shaft is inserted in a first mounting hole of the holding frame rotatably about its own axis;
a second shaft, wherein the second shaft is coupled to a second body of the electronic device, and the second shaft is inserted in a second mounting hole of the holding frame rotatably about its own axis,
wherein the first shaft is coupled to the second shaft by means of a flexible connecting member, and in response to the first shaft rotating about its own axis in a first direction, the first shaft operatively drives, by means of the flexible connecting member, the second shaft to rotate about its own axis in a direction opposite to the first direction.

16. The hinge of claim 15, wherein in response to the first shaft rotating about its own axis in the direction opposite to the first direction, the first shaft operatively drives, by means of the flexible connecting member, the second shaft to rotate about its own axis in the first direction.

17. The hinge of claim 16, wherein the flexible connecting member is a flexible shaft, the flexible shaft bends to form an arc, a first end of the flexible shaft is coupled to an end part of the first shaft, and a second end of the flexible shaft is coupled to an end part of the second shaft; and
in response to the first shaft rotating about its own axis, the flexible shaft operatively twists about its own axis from the first end to the second end and drives the second shaft to rotate about its own axis.

18. The hinge of claim 17, wherein the flexible shaft is a flexible shaft made of a flexible material, or a flexible shaft consisting of multiple strands of continuous filaments, or a flexible shaft consisting of multiple connecting blocks that are connected in sequence.

19. The hinge of claim 17, further comprising a support frame, wherein the support frame is fixed relative to the holding frame, a limit groove is provided on the holding frame, and the flexible connecting member is engaged in the limit groove.

20. The hinge of claim 15, wherein in response to the second shaft rotating in the first direction, the second shaft operatively drives, by means of the flexible connecting member, the first shaft to rotate about its own axis in the direction opposite to the first direction.
